(19) United States
(12) Patent Application Publication
(10) Pub. No.: US 2024/0353276 A1
(43) Pub. Date: Oct. 24, 2024

(54) CABLE FORCE IDENTIFICATION ALGORITHM CONSIDERING SEMI-RIGID CONSTRAINTS ON BOTH ENDS

(71) Applicants: DALIAN UNIVERSITY OF TECHNOLOGY, Dalian, Liaoning (CN); NATIONAL ASTRONOMICAL OBSERVATORIES, CHINESE ACADEMY OF SCIENCE, Beijing (CN)

(72) Inventors: Xing FU, Dalian, Liaoning (CN); Siyuan SUN, Dalian, Liaoning (CN); Qingwei LI, Dalian, Liaoning (CN); Hui LI, Dalian, Liaoning (CN); Hongnan LI, Dalian, Liaoning (CN)

(21) Appl. No.: 18/271,300

(22) PCT Filed: Oct. 10, 2022
(86) PCT No.: PCT/CN2022/124243

§ 371 Date: Jul. 7, 2023

(30) Foreign Application Priority Data
Oct. 5, 2022 (CN) 202211218386.4

(51) Int. Cl. G01L 5/04; G01L 1/10

(52) U.S. Cl. CPC G01L 5/042; G01L 1/10

(57) ABSTRACT

The present invention discloses a cable force identification algorithm considering semi-rigid constraints on both ends. The present invention only needs the basic parameters such as length and mass per unit length of a cable and then adopts a modal identification algorithm such as stochastic subspace method and frequency domain decomposition method to process signals collected by the acceleration sensor, and thus obtains the corresponding first natural frequency and mode shapes, and the cable force can be solved without obtaining any other data in advance. The present invention simplifies the cable to an equivalent single-degree-of-freedom system, modifies the first natural frequency of the cable through the mode shape of modal identification, avoids the cable force identification error caused by the change of the boundary mechanical characteristics of the cable, improves the efficiency and accuracy of cable force monitoring, has good application prospect in real-time monitoring of cable force of cable-stayed structure.

### TECHNICAL FIELD

The present invention relates to a cable force monitoring technology for cable structures such as cable net structures and suspension bridges, belonging to the technical field of engineering structural health monitoring, and is a cable force identification algorithm considering semi-rigid constraints on both ends, and specifically an exact calculation method for solving the axial tension of cable members from the first natural frequency and mode shapes at the mid-span and two endpoints of a cable when the boundary conditions at both ends of cable members can be simplified to semi-rigid constraints.

### BACKGROUND

Structures such as cable net structures and suspension bridges mainly transfer and distribute forces through cables, the cable is a unidirectional force member that only bears the tension, and is the main force member of the cable structures, and the cable force is a critical parameter for construction and evaluating the normal operating condition of the structure. For cable structures, the constraint conditions at both ends of the cable are very complex, and the boundary conditions are mostly semi-rigid constraints. These constraints typically consist of translational stiffness, while rotational stiffness can be ignored. Furthermore, the boundary conditions may vary depending on different working conditions. In 2007. Lu Yao. Wang Jinzhi and Chen Xiaojia from Wuhan University of Technology described the principle of measuring the cable force based on the string vibration theory in the Study on Measurement of Cable Force by Frequency Method, established the relationship between the natural frequency and the cable force, calculated the cable force by measuring the natural frequency of each order of a cable, and widely used the method in the construction control and structural health monitoring of the cable-stayed structure. However, the method is only applicable to the cable with hinge constraints on both ends. If the string vibration theory is used directly to calculate the cable force under other complex boundary conditions, a large identification error will be produced. In view of the above problem, the present invention provides a cable force identification algorithm considering semi-rigid constraints on both ends, which, in addition to retaining the advantage of convenience of calculation based on the string vibration theory, greatly improves the accuracy of cable force identification results under complex boundary conditions, provides a quick and simple analysis method for operation and maintenance personnel in cable force identification, and has a good application prospect in on-line monitoring of cable force of cable structures such as large cable net and suspension bridge.

### SUMMARY

The purpose of the present invention is to provide a cable force identification algorithm considering semi-rigid constraints on both ends for identifying the cable force of a semi-rigid constrained cable.

The technical solution of the present invention is as follows:

A cable force identification algorithm considering semi-rigid constraints on both ends, comprising the following steps:
Step 1: arranging an acceleration sensor vertically at the mid-span and both ends of a semi-rigid constrained cable respectively, and collecting vibration signals of the cable under environmental excitation or artificial excitation;
Step 2: processing the vibration signals collected in step 1 by the modal identification algorithm, and identifying the first natural frequency f₁ and mode shapes at the mid-span and two endpoints of the semi-rigid constrained cable;
Step 3: establishing a semi-rigid constrained cable model which is mainly composed of a cable, and a transverse support spring and an axial support spring on the left and right ends, simplifying the semi-rigid constrained cable model to an equivalent single-degree-of-freedom model, and calculating the generalized mass M* and the overall stiffness K* of the semi-rigid constrained cable;
(a) Calculating the generalized mass M* of the semi-rigid constrained cable

The first-order mode shape of hinged cables on both ends is

$${ϕ}_{0} sin \frac{π x}{l} ,$$

the mode shapes of transverse support springs on both ends are respectively ϕ₁ and ϕ₂, and the first-order mode shape of the semi-rigid constrained cable is the superposition of the first-order mode shape of the hinged cable and the mode shape of the transverse support spring and can be calculated by the following formula:

$${φ}_{1} ( x ) = ax + b + {ϕ}_{0} sin \frac{π x}{l} \qquad ( 1 )$$

$$a = \frac{{ϕ}_{2} - {ϕ}_{1}}{l} \qquad ( 2 )$$

$$b = {ϕ}_{1} \qquad ( 3 )$$

$${ϕ}_{0} = φ ( \frac{l}{2} ) - \frac{{ϕ}_{1} + {ϕ}_{2}}{2} \qquad ( 4 )$$

wherein x represents the horizontal coordinate along the length of the semi-rigid constrained cable; ϕ₀ represents the maximum mode shape value of the hinged cable; l represents the length of the semi-rigid constrained cable;

$$φ ( \frac{l}{2} )$$

represents the mode shape value at the midpoint of the semi-rigid constrained cable; and ϕ₀, ϕ₁, and ϕ₂ are normalized:

The generalized mass M* of the semi-rigid constrained cable is:

$$\begin{matrix}{M}^{*} = {\int }_{0}^{l} \overline{m} {{φ}_{1} ( x )}^{2} dx \\ = {\int }_{0}^{l} {\overline{m} ( ax + b + {ϕ}_{0} sin \frac{π x}{l} )}^{2} dx \\ = {\int }_{0}^{l} \overline{m} ( {a}^{2} {x}^{2} + {b}^{2} + {ϕ}_{0}^{2} {sin}^{2} \frac{π x}{l} + \\ 2 abx + 2 a {ϕ}_{0} x sin \frac{π x}{l} + 2 b {ϕ}_{0} sin \frac{π x}{l} ) dx \\ = {\int }_{0}^{l} \overline{m} ( {a}^{2} {x}^{2} + {b}^{2} + \frac{1}{2} {ϕ}_{0}^{2} ( 1 - cos \frac{2 π x}{l} ) + \\ 2 abx + 2 a {ϕ}_{0} x sin \frac{π x}{l} + 2 b {ϕ}_{0} sin \frac{π x}{l} ) dx \\ = \overline{m} l ( \frac{1}{3} {a}^{2} {l}^{2} + {b}^{2} + \frac{1}{2} {ϕ}_{0}^{2} + abl + \frac{2 a {ϕ}_{0} l}{π} + \frac{4}{π} b {ϕ}_{0} )\end{matrix} \qquad ( 5 )$$

wherein m̅ represents the mass per unit length of the semi-rigid constrained cable:
(b) Calculating the overall stiffness K* of the equivalent single-degree-of-freedom model for the semi-rigid constrained cable

The equivalent single-degree-of-freedom model of the semi-rigid constrained cable is mainly composed of a spring with the equivalent lumped mass point of m₀* and the stiffness coefficient of k₀* and transverse support springs on the left and right ends; and the overall stiffness K* of the equivalent single-degree-of-freedom model for the semi-rigid constrained cable is calculated by the following formula:

$${K}^{*} = \frac{1}{\frac{1}{{k}_{0}^{*}} + \frac{{ϕ}_{1}}{4 {ϕ}_{1} {k}_{1}} + \frac{{ϕ}_{2}}{4 {ϕ}_{2} {k}_{2}}} = \frac{4 {ϕ}_{1} {k}_{1} {k}_{0}^{*}}{4 {ϕ}_{1} {k}_{1} + {k}_{0}^{*} ( {ϕ}_{1} + {ϕ}_{2} )} \qquad ( 6 )$$

wherein k; represents the generalized stiffness of the single-degree-of-freedom system of the hinged cable; and k₁ and k₂ represent the stiffness of the transverse support springs on the left and right ends of the semi-rigid constrained cable respectively:

For the semi-rigid constrained cable on both ends, the first natural frequency is f₁, the first-order natural circular frequency is ω₁, and it can be known from the fundamental vibration characteristics of the single-degree-of-freedom system that the relationship among K*, M*, f₁ and ω₁ can be expressed by the following formula:

$${ω}_{1} = \sqrt{\frac{{K}^{*}}{{M}^{*}}} = 2 π {f}_{1} \qquad ( 7 )$$

Step 4: establishing the equivalent single-degree-of-freedom model of the hinged cables on both ends, which is composed of a spring with the equivalent lumped mass point of m₀* and the stiffness coefficient of k₀*, then calculating the generalized stiffness k₀* of the hinged cables on both ends, and modifying the first natural frequency of the semi-rigid constrained cable:

The generalized stiffness k; of the equivalent single-degree-of-freedom model of the hinged cables on both ends is:

$${k}_{0}^{*} = \frac{16 {M}^{*} {ω}_{1}^{2} {ϕ}_{1} fT}{16 f {ϕ}_{1} T - {M}^{*} {ω}_{1}^{2} l ( {ϕ}_{1} + {ϕ}_{2} ) {y}_{1}} \qquad ( 8 )$$

wherein f represents the mid-span sag of the hinged cable, which is the maximum displacement of the hinged cables on both ends; T represents the measured cable force of the semi-rigid constrained cable; and y₁ represents the equivalent displacement of the transverse support spring of the semi-rigid constrained cable:

It can be known from the fundamental vibration characteristics of the single-degree-of-freedom system that the relationship among k₀*, m₀*, f₀ and ω₀ is as follows:

$${ω}_{0} = \sqrt{\frac{{k}_{0}^{*}}{{m}_{0}^{*}}} = 2 π {f}_{0} \qquad ( 9 )$$

The first generalized mass m₀* of the hinged cables on both ends is

$$\frac{1}{2} \overline{m} l ,$$

and the first-order natural circular frequency ω₀ and the first natural frequency f₀ of the hinged cables on both ends are obtained respectively as follows through formula (9):

$${ω}_{0} = \sqrt{\frac{{k}_{0}^{*}}{{m}_{0}^{*}}} = {\{ \frac{32 {M}^{*} {ω}_{1}^{2} {ϕ}_{1} f T}{\overline{m} l [ 16 f {ϕ}_{1} T - {M}^{*} {ω}_{1}^{2} l ( {ϕ}_{1} + {ϕ}_{2} ) {y}_{1} ]} \}}^{\frac{1}{2}} \qquad ( 10 )$$

$${f}_{0} = \frac{{ω}_{0}}{2 π} = {\{ \frac{8 {M}^{*} {ω}_{1}^{2} {ϕ}_{1} f T}{{π}^{2} \overline{m} l [ 16 f {ϕ}_{1} T - {M}^{*} {ω}_{1}^{2} l ( {ϕ}_{1} + {ϕ}_{2} ) {y}_{1} ]} \}}^{\frac{1}{2}} \qquad ( 11 )$$

Step 5: substituting the modified first natural frequency into the cable force-frequency relation equation to solve the cable force.

$$T = \frac{{M}^{*} {ω}_{1}^{2} l [ 32 {ϕ}_{1} f + {π}^{2} ( {ϕ}_{1} + {ϕ}_{2} ) {y}_{1} ]}{16 {π}^{2} {ϕ}_{1} f} = \frac{{M}^{*} {ω}_{1}^{2} l [ 32 {ϕ}_{1} + {π}^{2} ( {ϕ}_{1} + {ϕ}_{2} ) \frac{{y}_{1}}{f} ]}{16 {π}^{2} {ϕ}_{1}} \qquad ( 12 )$$

wherein

$$\frac{{y}_{1}}{f} = \frac{{ϕ}_{1}}{{ϕ}_{0}} .$$

The present invention has the following beneficial effects:
(1) The present invention only needs the basic parameters such as length and mass per unit length of a cable and then adopts a modal identification algorithm to process signals collected by the acceleration sensor, and thus obtains the corresponding first natural frequency and mode shapes, and the cable force can be solved without obtaining any other data in advance.
(2) Compared with the existing string vibration theory, the present invention simplifies the cable to an equivalent single-degree-of-freedom system, modifies the first natural frequency of the semi-rigid constrained cable through the mode shape of modal identification, avoids the cable force identification error caused by the change of the boundary mechanical characteristics of the cable, broadens the engineering applicability of the string vibration theory, and has strong innovativeness.
(3) The present invention has simple implementation and high efficiency and accuracy of cable force monitoring, and has a very good application prospect in the real-time monitoring of cable force of the cable-stayed structure. The method is very suitable for the structure in which the boundary mechanical properties of the cable change continuously with the working conditions in actual operation, and has strong practicability and wide applicability.

### DESCRIPTION OF DRAWINGS

FIG. 1 shows the cable acceleration time-histories provided by embodiments of the present invention;

FIG. 2 is a stability diagram of cable modal identification provided by embodiments of the present invention:

FIG. 3 shows a simplified mechanical model of a main cable provided by embodiments of the present invention:

FIG. 4 shows an equivalent single-degree-of-freedom model of a semi-rigid constrained cable provided by embodiments of the present invention:

FIG. 5 shows a mode shape of a semi-rigid constrained cable provided by embodiments of the present invention:

FIG. 6 shows an equivalent single-degree-of-freedom model of a hinged cable provided by embodiments of the present invention:

FIG. 7 is a flow chart of a cable force identification algorithm of a semi-rigid constrained cable provided by embodiments of the present invention.

### DETAILED DESCRIPTION

To make the purpose, features and advantages of the present invention more clear and legible, the technical solution in the embodiments of the present invention will be clearly and fully described below in combination with the drawings in the embodiment of the present invention. Apparently, the described embodiment is merely part of the embodiments of the present invention, not all of the embodiments. Based on the embodiments in the present invention, all other embodiments obtained by those ordinary skilled in the art without contributing creative labor will belong to the protection scope of the present invention.

A cable force identification program considering semi-rigid constraints on both ends, comprising:

A collection module, used for acquiring the acceleration data of the semi-rigid constrained cable:

A memory, used for storing the acquired acceleration data and computer programs:

A processor, used for executing the computer programs stored in the memory, and when the computer programs are executed, the processor is used for:

Reading the stored acceleration data which is the acceleration response data collected and stored at the same sampling frequency within the same time and collected at the mid-span and two endpoints of the semi-rigid constrained cable; according to the acceleration response data, the modal identification program extracts the first natural frequency and mode shapes at the mid-span and two endpoints of the semi-rigid constrained cable; and finally, the cable force identification program outputs cable force identification results based on the length, the mass per unit length, the first natural frequency and the mode shape of the semi-rigid constrained cable.

The specific process is as follows:

As shown in FIG. 1 to FIG. 7.

An embodiment of the present invention is the Five-hundred-meter Aperture Spherical radio Telescope (FAST) which is located in the Qiannan Buyi and Miao Autonomous Prefecture, Guizhou, China, and is the world's largest and most sensitive single-aperture radio telescope at present. The main structure of FAST is a huge cable net woven from 6,670 ropes about 11 m long and 4,450 reflection units, which is a cable net structure with the largest span and highest precision in the world, and also the world's first cable net system using displacement; and the boundary conditions of the main cable in the cable net are semi-rigid constraints, so the boundary conditions of the main cable can be simplified to constrained springs for axial support and transverse support on both ends.

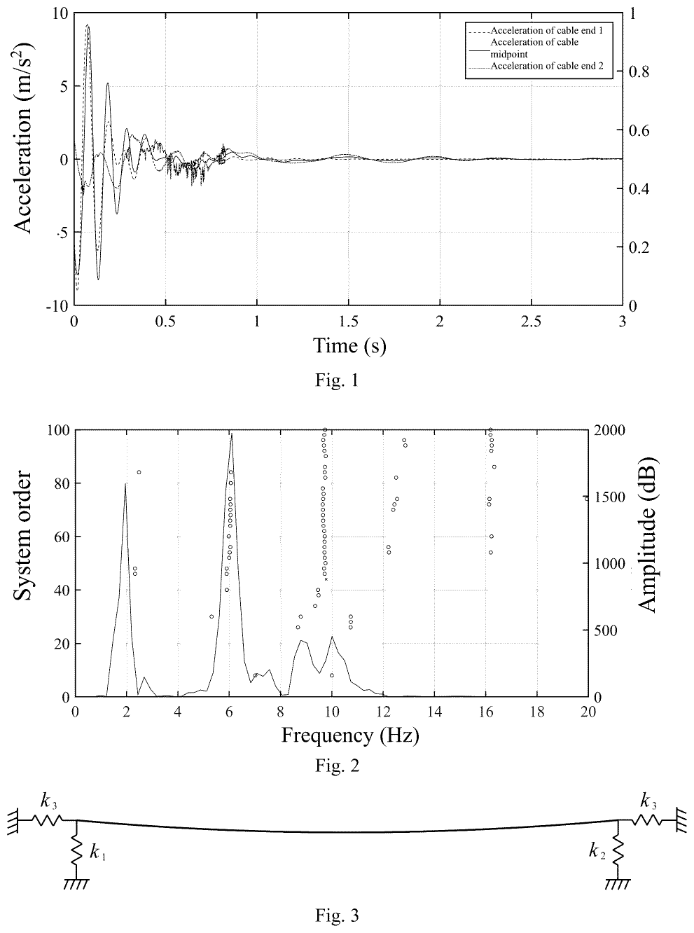

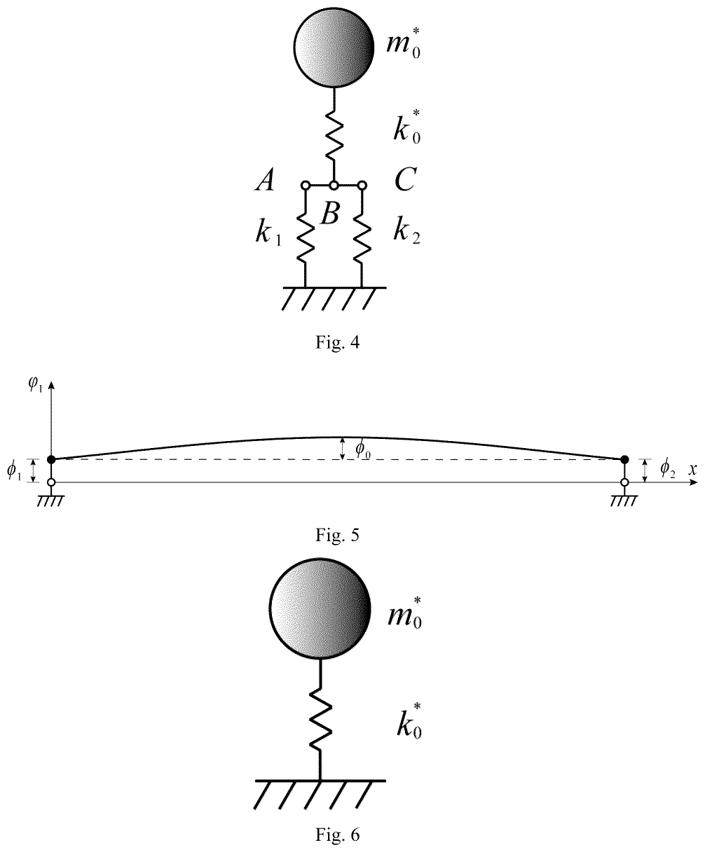

A cable in the FAST cable net is taken as an object of cable force identification, and the geometric and mechanical parameters thereof are as follows: No. 6587 cable is a cable at the edge of zone A in the overall FAST cable net, with the length of 9.24 m; the specification of the cable is S9; the nominal area is 1260 mm²; the Young's modulus is 2.25 E¹¹ Pa; and the mass per linear meter of the cable is 12.524 kg/m. At the same time, the present embodiment compares the calculation result of the present invention with the tensile force of the loaded cable in the stable state in finite element software, the software adopted is general finite element analysis software ANSYS, the number of cable units is 30, and the initial configuration of the cable is determined by the cyclic form finding method. In the present invention, the cable force is determined by the following steps:
Step 1: applying an initial load to the No. 6587 cable, then releasing the load, simulating free vibration, and extracting the acceleration responses of two endpoints and the midpoint of the cable by commands of the ANSYS finite element software, as shown in FIG. 1;
Step 2: processing the collected vibration signals by the stochastic subspace modal identification algorithm, and obtaining the following results by identification: the first natural frequency of the semi-rigid constrained cable is f₁=9.69 Hz, the mode shape at the midpoint of the cable is 63.1847, the mode shape of a cable end 1 is 31.4913, the mode shape of a cable end 2 is 1.4718, and the stability diagram of modal identification is shown in FIG. 2;
Step 3: establishing a semi-rigid constrained cable model, simplifying the model to an equivalent single-degree-of-freedom model, as shown in FIG. 3 and FIG. 4, and calculating the generalized mass M* and the overall stiffness K* of the semi-rigid constrained cable;

### (a) Calculating the Generalized Mass M* of the Semi-Rigid Constrained Cable

Normalizing the mode shapes identified in step 2 to obtain ϕ₁=0.4908 and ϕ₂=0.0229, and the first-order mode shape of the semi-rigid constrained cable is shown in FIG. 5 and can be calculated by the following formula:

$${φ}_{1} ( x ) = a x + b + {ϕ}_{0} sin \frac{π x}{l} = - 0.0506 x + 0.4908 + 0.7279 sin \frac{π x}{9.24} \qquad ( 13 )$$

$$a = \frac{{ϕ}_{2} - {ϕ}_{1}}{l} = \frac{0.0229 - 04908}{9.24} = - 0.0506 \qquad ( 14 )$$

$$b = {ϕ}_{1} = 0.4 \; 908 \qquad ( 15 )$$

$${ϕ}_{0} = φ ( \frac{l}{2} ) - \frac{{ϕ}_{1} + {ϕ}_{2}}{2} = 0.9847 - \frac{0.4908 + 0.0229}{2} = 0.7279 \qquad ( 16 )$$

wherein ϕ₀ represents the maximum mode shape value of the hinged cable; ϕ₁ and ϕ₂ are respectively the mode shape values of the transverse constrained springs on both ends; and/is the length of the cable, the same below:

It can be known that the first generalized mass M* of the semi-rigid constrained cable is:

$${M}^{*} = \overline{m} l ( \frac{1}{3} {a}^{2} {l}^{2} + {b}^{2} + \frac{1}{2} {ϕ}_{0}^{2} + a b l + \frac{2 a {ϕ}_{0} l}{π} + \frac{4}{π} b {ϕ}_{0} ) = 67.9 \; 463 kg \qquad ( 17 )$$

wherein m̅ is the mass per unit length of the cable, the same below.

### (b) Calculating the Overall Stiffness K* of the Equivalent Single-Degree-of-Freedom Model of the Semi-Rigid Constrained Cable

The overall stiffness K* of the equivalent single-degree-of-freedom model of the semi-rigid constrained cable can be calculated by the following formula:

$$\begin{matrix}{K}^{*} = \frac{1}{\frac{1}{{k}_{0}^{*}} + \frac{{ϕ}_{1}}{4 {ϕ}_{1} {k}_{1}} + \frac{{ϕ}_{2}}{4 {ϕ}_{2} {k}_{2}}} \\ = \frac{4 {ϕ}_{1} {k}_{1} {k}_{0}^{*}}{4 {ϕ}_{1} {k}_{1} + {k}_{0}^{*} ( {ϕ}_{1} + {ϕ}_{2} )}\end{matrix} \qquad ( 18 )$$

wherein k₀* is the generalized stiffness of the single-degree-of-freedom system of the hinged cable; and k₁ and k₂ are the stiffness of the transverse constrained springs on both ends of the semi-rigid constrained cable respectively:

For the semi-rigid constrained cable on both ends, the first natural frequency is f₁, the first-order natural circular frequency is ω₁, and the relationship among the above vibration characteristic parameters is shown in the following formula:

$${ω}_{1} = \sqrt{\frac{{K}^{*}}{{M}^{*}}} = 2 π {f}_{1} = 60.9 \; 469 rad / s \qquad ( 19 )$$

Step 4: establishing the equivalent single-degree-of-freedom model of the hinged cables on both ends, as shown in FIG. 6, then calculating the generalized stiffness k₀* of the hinged cables on both ends, and modifying the first natural frequency of the semi-rigid constrained cable;

The generalized stiffness k₀* of the equivalent single-degree-of-freedom model of the hinged cables on both ends is:

$${k}_{0}^{*} = \frac{16 {M}^{*} {ω}_{1}^{2} {ϕ}_{1} fT}{16 f {ϕ}_{1} T - {M}^{*} {ω}_{1}^{2} l ( {ϕ}_{1} + {ϕ}_{2} ) {y}_{1}} \qquad ( 20 )$$

wherein f represents the mid-span sag of the hinged cable, which is the maximum displacement of the hinged cables on both ends; T represents the measured cable force; and y₁ represents the equivalent displacement of the transverse constrained spring of the semi-rigid constrained cable, the same below:

It can be known from the fundamental vibration characteristics of the single-degree-of-freedom system that the relationship among the above vibration characteristic parameters is as follows:

$${ω}_{0} = \sqrt{\frac{{k}_{0}^{*}}{{m}_{0}^{*}}} = 2 π {f}_{0} \qquad ( 21 )$$

The first generalized mass m₀* of the hinged cables on both ends is

$$\frac{1}{2} \overline{m} l = 57.8 \; 621 kg .$$

and the first-order natural circular frequency ω₀ and the first natural frequency f₀ are obtained respectively as follows through formula (21):

$${ω}_{0} = \sqrt{\frac{{k}_{0}^{*}}{{m}_{0}^{*}}} = {\{ \frac{32 {M}^{*} {ω}_{1}^{2} {ϕ}_{1} fT}{\overline{m} l [ 16 f {ϕ}_{1} T - {M}^{*} {ω}_{1}^{2} l ( {ϕ}_{1} + {ϕ}_{2} ) {y}_{1} ]} \}}^{\frac{1}{2}} \qquad ( 22 )$$

$${f}_{0} = \frac{{ω}_{0}}{2 π} = {\{ \frac{8 {M}^{*} {ω}_{1}^{2} {ϕ}_{1} fT}{{π}^{2} \overline{m} l [ 16 f {ϕ}_{1} T - {M}^{*} {ω}_{1}^{2} l ( {ϕ}_{1} + {ϕ}_{2} ) {y}_{1} ]} \}}^{\frac{1}{2}} \qquad ( 23 )$$

Step 5: substituting the modified first natural frequency into the cable force-frequency relation equation, and solving the cable force after sorting; the cable force-frequency relation equation is shown as follows:

$$T = 4 \overline{m} {l}^{2} {f}_{0}^{2} \qquad ( 24 )$$

The semi-rigid constrained cable vibrates according to the mode shape of formula (13), so the ratio of initial displacements between particles shall have the ratio relationship of the mode shape, that is

$$\frac{{y}_{1}}{f} = \frac{{ϕ}_{1}}{{ϕ}_{0}} .$$

Therefore, the cable force is calculated as follows:

$$T = \frac{{M}^{*} {ω}_{1}^{2} l [ 32 {ϕ}_{1} f + {π}^{2} ( {ϕ}_{1} + {ϕ}_{2} ) {y}_{1} ]}{16 {π}^{2} {ϕ}_{1} f} = \frac{{M}^{*} {ω}_{1}^{2} l [ 32 {ϕ}_{1} + {π}^{2} ( {ϕ}_{1} + {ϕ}_{2} ) \frac{{y}_{1}}{f} ]}{16 {π}^{2} {ϕ}_{1}} = 575.44 kN \qquad ( 25 )$$

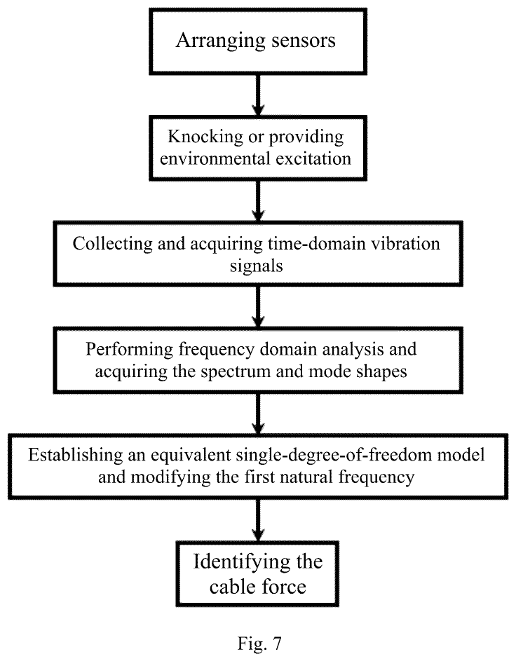

The cable force of the No. 6587 cable in the FAST cable net is calculated by the cable force identification algorithm for the semi-rigid constrained cable of the present invention, the first natural frequency of the cable is modified by the mode shape to realize cable force inversion, and the cable force is finally obtained as 575.44 kN. With the actual cable force 572.05 kN extracted by the ANSYS finite element software as the basis, the cable force calculated in the present invention is 575.44 kN, and the relative error is only 0.59%, while the traditional string vibration theory adopts an unmodified first natural frequency to calculate the cable force as 401.79 kN, and the relative error is −29.76%; and the accuracy of the two is different by tens of times. Therefore, the cable force identification algorithm for the semi-rigid constrained cable proposed in the present invention can simply, accurately and efficiently complete cable force identification and greatly reduce the cost of labor and equipment in the operation and maintenance of cable structures, and has strong practicability and wide applicability. In order to make the application of the present invention more clear to users, the present invention provides the specific steps, as shown in FIG. 7.

The above embodiment is only used for describing the technical solution of the present invention rather than limiting the same. Although the present invention is described in detail by referring to the above embodiments, those ordinary skilled in the art should understand that the technical solution recorded in each of the above embodiments can be still amended, or some technical features therein can be replaced equivalently. However, these amendments or replacements do not enable the essence of the corresponding technical solutions to depart from the spirit and the scope of the technical solutions of various embodiments of the present invention.

1. A cable force identification algorithm considering semi-rigid constraints on both ends, comprising the following steps:
step 1: arranging an acceleration sensor vertically at the mid-span and both ends of a semi-rigid constrained cable respectively, and collecting vibration signals of the cable under environmental excitation or artificial excitation;
step 2: processing the vibration signals collected in step 1 by the modal identification algorithm, and identifying the first natural frequency f₁ and mode shapes at the mid-span and two endpoints of the semi-rigid constrained cable;
step 3: establishing a semi-rigid constrained cable model which is mainly composed of a cable, and a transverse support spring and an axial support spring on the left and right ends, simplifying the semi-rigid constrained cable model to an equivalent single-degree-of-freedom model, and calculating the generalized mass M* and the overall stiffness K* of the semi-rigid constrained cable;
(a) calculating the generalized mass M* of the semi-rigid constrained cable
the first-order mode shape of hinged cables on both ends is
$${ϕ}_{0} sin \frac{π x}{l} ,$$
the mode shapes of transverse support springs on both ends are respectively ϕ₁ and ϕ₂, and the first-order mode shape of the semi-rigid constrained cable is the superposition of the first-order mode shape of the hinged cable and the mode shape of the transverse support spring and can be calculated by the following formula:
$${φ}_{1} ( x ) = a x + b + {ϕ}_{0} sin \frac{π x}{l} \qquad ( 26 )$$
$$a = \frac{{ϕ}_{2} - {ϕ}_{1}}{l} \qquad ( 27 )$$
$$b = {ϕ}_{1} \qquad ( 28 )$$
$${ϕ}_{0} = φ ( \frac{l}{2} ) - \frac{{ϕ}_{1} + {ϕ}_{2}}{2} \qquad ( 29 )$$
wherein x represents the horizontal coordinate along the length of the semi-rigid constrained cable; ϕ₀ represents the maximum mode shape value of the hinged cable; l represents the length of the semi-rigid constrained cable:
$$φ ( \frac{l}{2} )$$
represents the mode shape value at the midpoint of the semi-rigid constrained cable; and ϕ₀, ϕ₁ and ϕ₂ are normalized:
the generalized mass M* of the semi-rigid constrained cable is:
$${M}^{*} = {\int }_{0}^{l} \overline{m} {{φ}_{1} ( x )}^{2} dx = \overline{m} l ( \frac{1}{3} {a}^{2} {l}^{2} + {b}^{2} + \frac{1}{2} {ϕ}_{0}^{2} + abl + \frac{2 a {ϕ}_{0} l}{π} + \frac{4}{π} b {ϕ}_{0} ) \qquad ( 30 )$$
wherein m̅ represents the mass per unit length of the semi-rigid constrained cable:
(b) calculating the overall stiffness K* of the equivalent single-degree-of-freedom model for the semi-rigid constrained cable
the equivalent single-degree-of-freedom model of the semi-rigid constrained cable is mainly composed of a spring with the equivalent lumped mass point of m₀* and the stiffness coefficient of k₀* and transverse support springs on the left and right ends; and the overall stiffness K* of the equivalent single-degree-of-freedom model for the semi-rigid constrained cable is calculated by the following formula:
$$\begin{matrix}{K}^{*} = \frac{1}{\frac{1}{{k}_{0}^{*}} + \frac{{ϕ}_{1}}{4 {ϕ}_{1} {k}_{1}} + \frac{{ϕ}_{2}}{4 {ϕ}_{2} {k}_{2}}} \\ = \frac{4 {ϕ}_{1} {k}_{1} {k}_{0}^{*}}{4 {ϕ}_{1} {k}_{1} + {k}_{0}^{*} ( {ϕ}_{1} + {ϕ}_{2} )}\end{matrix} \qquad ( 31 )$$
wherein k₀* represents the generalized stiffness of the single-degree-of-freedom system of the hinged cable; and k₁ and k₂ represent the stiffness of the transverse support springs on the left and right ends of the semi-rigid constrained cable respectively:
for the semi-rigid constrained cable on both ends, the first natural frequency is f₁, the first-order natural circular frequency is ω₁, and according to the fundamental vibration characteristics of the single-degree-of-freedom system, the relationship among K*, M′, f₁ and ω₁ is expressed by the following formula:
$${ω}_{1} = \sqrt{\frac{{K}^{*}}{{M}^{*}}} = 2 π {f}_{1} \qquad ( 32 )$$
step 4: establishing the equivalent single-degree-of-freedom model of the hinged cables on both ends, which is composed of a spring with the equivalent lumped mass point of m₀* and the stiffness coefficient of k₀*, then calculating the generalized stiffness k₀* of the hinged cables on both ends, and modifying the first natural frequency of the semi-rigid constrained cable;
the generalized stiffness k₀* of the equivalent single-degree-of-freedom model of the hinged cables on both ends is:
$${k}_{0}^{*} = \frac{16 {M}^{*} {ω}_{1}^{2} {ϕ}_{1} fT}{16 f {ϕ}_{1} T - {M}^{*} {ω}_{1}^{2} l ( {ϕ}_{1} + {ϕ}_{2} ) {y}_{1}} \qquad ( 33 )$$
wherein f represents the mid-span sag of the hinged cable, which is the maximum displacement of the hinged cables on both ends; T represents the measured cable force of the semi-rigid constrained cable; and y₁ represents the equivalent displacement of the transverse support spring of the semi-rigid constrained cable:
it can be known from the fundamental vibration characteristics of the single-degree-of-freedom system that the relationship among k₀*, m₀*, f₀ and ω₀ is as follows:
$${ω}_{0} = \sqrt{\frac{{k}_{0}^{*}}{{m}_{0}^{*}}} = 2 π {f}_{0} \qquad ( 34 )$$
the first generalized mass m₀* of the hinged cables on both ends is
$$\frac{1}{2} \overline{m} l ,$$
and the first-order natural circular frequency ω₀ and the first natural frequency f₀ of the hinged cables on both ends are obtained respectively as follows through formula (9):
$${ω}_{0} = \sqrt{\frac{{k}_{0}^{*}}{{m}_{0}^{*}}} = {\{ \frac{32 {M}^{*} {ω}_{1}^{2} {ϕ}_{1} fT}{\overline{m} l [ 16 f {ϕ}_{1} T - {M}^{*} {ω}_{1}^{2} l ( {ϕ}_{1} + {ϕ}_{2} ) {y}_{1} ]} \}}^{\frac{1}{2}} \qquad ( 35 )$$
$${f}_{0} = \frac{{ω}_{0}}{2 π} = {\{ \frac{8 {M}^{*} {ω}_{1}^{2} {ϕ}_{1} fT}{{π}^{2} \overline{m} l [ 16 f {ϕ}_{1} T - {M}^{*} {ω}_{1}^{2} l ( {ϕ}_{1} + {ϕ}_{2} ) {y}_{1} ]} \}}^{\frac{1}{2}} \qquad ( 36 )$$
step 5: substituting the modified first natural frequency into the cable force-frequency relation equation to solve the cable force:
$$T = \frac{{M}^{*} {ω}_{1}^{2} l [ 32 {ϕ}_{1} f + {π}^{2} ( {ϕ}_{1} + {ϕ}_{2} ) {y}_{1} ]}{16 {π}^{2} {ϕ}_{1} f} = \frac{{M}^{*} {ω}_{1}^{2} l [ 32 {ϕ}_{1} + {π}^{2} ( {ϕ}_{1} + {ϕ}_{2} ) \frac{{y}_{1}}{f} ]}{16 {π}^{2} {ϕ}_{1}} \qquad ( 37 )$$
wherein
$$\frac{{y}_{1}}{f} = \frac{{ϕ}_{1}}{{ϕ}_{0}} .$$

2. A cable force identification program considering semi-rigid constraints on both ends, comprising:
a collection module, used for acquiring the acceleration data of the semi-rigid constrained cable;
a memory, used for storing the acquired acceleration data and computer programs;
a processor, used for executing the computer programs stored in the memory, and when the computer programs are executed, the processor is used for:
reading the stored acceleration data which is the acceleration response data collected and stored at the same sampling frequency within the same time and collected at the mid-span and two endpoints of the semi-rigid constrained cable; according to the acceleration response data, the modal identification program extracts the first natural frequency and mode shapes at the mid-span and two endpoints of the semi-rigid constrained cable; and finally, the cable force identification program outputs cable force identification results based on the length, the mass per unit length, the first natural frequency and the mode shape of the semi-rigid constrained cable.
